(19) United States
(12) Patent Application Publication
(10) Pub. No.: US 2010/0154831 A1
(43) Pub. Date: Jun. 24, 2010

(54) WARE WASHING SYSTEM CONTAINING POLYSACCHARIDE

(75) Inventors: Antonius Maria Neplenbroek, Soest (NL); Fabien Bruno Dusart, Rillieux-la-Pape (FR); Diedrick Hendricus Van Drunen, De Bilt (NL); Amandine Aurelie Marie Houche, Paris (FR)

Correspondence Address: Diversey, Inc., 8310 16TH STREET, M/S 509, PO BOX 902, STURTEVANT, WI, 53177-0902, US

(73) Assignee: JOHNSONDIVERSEY, INC, Sturtevant, WI (US)

(21) Appl. No.: 12/601,288

(22) PCT Filed: May 23, 2008
(86) PCT No.: PCT/US08/64626

§ 371 Date: Jan. 25, 2010

(30) Foreign Application Priority Data
May 25, 2007 (EP) 07108958.5

(51) Int. Cl. A47L 15/44; B08B 3/00

(52) U.S. Cl. 134/25.2

(57) ABSTRACT

A method of washing ware, in particular in an automatic institutional ware washing machine, is disclosed, using a detergent composition containing a polysaccharide, which eliminates the need for a surfactant in the rinse step. The polysaccharide provides a layer of polysaccharide on the ware so as to afford a sheeting action in an aqueous rinse step without any added rinse agent.

### FIELD OF THE INVENTION

This invention relates to a ware washing process using a detergent that promotes soil removal in the washing stage and rinsing or rinse water sheeting in the rinsing stage.

### BACKGROUND OF THE INVENTION

Current institutional warewash processes involve at least 2 steps; Step 1 which is a main wash, in which the substrates are cleaned by pumping main wash solution over the substrates via nozzles. This main wash solution is obtained by dissolving main wash detergent, which can contain components such as alkalinity agents, builders, bleaches, enzymes, surfactants for defoaming or cleaning, polymers, corrosion inhibitors etc. Step 2 is a rinse step after the main wash. This is done by flowing warm or hot water, containing rinse aid solution, over the substrates, which can be followed by a hot air stream to further improve the drying process. The rinse aid typically consists of non-ionics present in an amount of 10 to 30% in water; often in combination with hydrotropes and sometimes other additives such as polymers, silicones, acids, etc.

A number of machines are used for these institutional warewash processes, such as the so called single tank, dump or multi-tank machines. Typical conditions in these institutional warewash processes are:

A. Constant temperature of main wash in a single tank and dump machines of 50-70° C.

B. Temperature of wash solution in multi-tank machine is about 40° C. in the first (prewash) tank and about 60° C. in the last wash tank.

C. High temperature of rinse solution of 80-90° C. for single tank and multi-tank machine and about 60° C. for dump machines.

D. Short total wash cycles varying from about 40 seconds to 5 minutes. The rinse cycle does not take longer than 2 minutes, and in most cases takes only between 2 and 10 seconds.

E. Wash water being re-used for many wash cycli (with exception of dump machines)

F. Volume of wash solution varying from about 5 to 10 Liter (for dump machine) to 40 Liter (for Single tank re-use machine) to 400 Liter (for multi-tank machine).

G. No carry-over of main wash solution to the final rinse solution for the so called high temperature single- and multi-tank machines. Different pumps, tubes and nozzles are used for the wash solution and rinse solution and the rinse solution is not recirculating through the wash tank during the last rinse.

H. The substrates have to be dry after the final rinse, since this is a more or less continuous batch process where the substrates are cleared away before the next batch of washed and dried substrates are coming out of the machine. These machines are used at facilities (like restaurants, hospitals, cantines) where many substrates are washed in a short period of time.

The machine and process conditions for these institutional dishwashing processes differ significantly from the conditions for domestic type of dishwash machines. Most important features of domestic dishwashing that differ from institutional ware washing are:

A. Domestic dishwash process takes about 30 minutes to 1.5 hour. The rinse cycles in these processes vary from about 5 to 40 minutes.

B. Wash solution is not re-used in the domestic dishwash process

C. Part of the wash solution is carried over into the rinse solution (e.g. via the same pump, tubes and nozzles that are used for washing and rinsing and because the rinse solution is recirculated through the wash tank during rinsing).

D. Temperature in domestic wash process is totally different; normally cold water is used for filling the machines. This water is heated up to about 60 degrees C. during the wash process.

E. Volume wash solution is about 3 to 10 Liter.

F. After the wash and rinse process there is sufficient time left for the substrates to dry further. This is facilitated by the warm conditions in the closed domestic dishwash machine.

An important recent trend in domestic dishwashing is the development of dishwash products which can be used in domestic dishwash machines without the need for a separate rinse product to be added to the final rinse solution. A key driver for this development is simplicity.

These products, often tablets, contain ingredients which facilitate the drying process. The main objective is to obtain improved visual appearance of the substrates. The most important drying-ingredients in these, so called 2-in-1 or 3-in-1 products, are polymers and non-ionics.

Crucial parameters/conditions for obtaining acceptable drying properties by this so called built-in rinse concept in domestic dishwashing machines are:

A. Carry-over of some part of the main wash solution, containing the drying ingredients, into the rinse solution. This carry-over typically takes place via the same pump, tubes and nozzles that are used for washing and rinsing and because the rinse solution is recirculated through the wash tank with dish ware during rinsing.

B. Relatively long washing time and rinsing time.

C. Relatively high area of machine surface (walls) and dish ware, on which drying components (polymers and non-ionics) will remain in the residual water that clings onto the machine parts and the dish ware. A part of the rinse components in the last rinse solution is derived from this residual water. This process of carry over of rinse components from the main wash into the rinse solution will be stimulated further when a part of the wash solution is present as foam at the end of the main wash cycle.

Despite these conditions, the drying results in domestic dishwashing machines by these tablets with built-in rinse components is often inferior to drying by adding rinse component into the rinse via a separate rinse aid.

Institutional ware washing processes are characterised by very short wash and rinse cycles, i.e. by a very short contact time between the wash solution and the substrates and between the rinse solution and the substrates. In addition, in institutional high temperature single- and multi-tank machines there is no carry-over of the wash solution via the pump, tubes and nozzles of the machine and no carry-over by adsorption and subsequent desorption via the machine walls (since the rinse solution is not recirculated in the wash tank). Therefore, the concept of built-in rinse components is not expected to work in institutional ware washing processes. Furthermore, reduced drying times are much more important for institutional ware washing processes than for domestic dishwashing, where emphasis is on visual appearance.

Therefore, almost all proper ware washing processes in institutional ware washing machines require the need for rinse components to be present in the final rinse solution, which are introduced by dosing a separate rinse aid in this rinse solution.

One effective attempt to develop a main wash detergent product for institutional ware washing machines with a built-in rinse component is described in international patent application WO 2006/119162. This patent application discloses that a low level of specific non-ionic and polymeric surfactants present in the main wash process adsorb onto the ware resulting in a sheeting action. This results in faster drying of the substrates when rinsed with fresh water. However, the polymeric surfactants providing good drying in tap water do not lead to significant drying benefits in soft water.

JP2005068327 describes a detergent with little foaming ability, little corrosiveness and great detergency, for example useful for an automatic dishwasher. This detergent comprises a water-soluble polysaccharide and/or its derivative. Preferably, the water-soluble polysaccharide is cyclodextrin or its derivative. No reference is made to a sheeting action of the polysaccharide.

JP2007099811 describes a detergent composition for a dish washer, capable of speeding up removal of stains, drying of dishes and reducing water spots without using any rinse agent. The detergent composition for the dish washer contains (A) at least one polymeric compound chosen from a water-soluble polysaccharide and a polymer compound containing a structural unit derived from a cationic monomer and (B) at least one nonionic surfactant of a specific formula (I) and/or (II) in a weight ratio (A)/(B) of from 3/1 to 1/5. The polysaccharide exemplified in this document does not show an appropriate performance in the method of the present invention.

Thus, there is a need for compounds that provide good drying also in soft water and make the concept of built-in rinse aid for institutional ware washing applicable in a wide range of water conditions.

### DESCRIPTION OF THE INVENTION

A method of washing ware is provided using a detergent composition containing a polysaccharide. The use of a polysaccharide in the ware washing detergent advantageously provides an improved drying behaviour of the ware, when rinsing is performed with an aqueous rinse that is substantially free of an intentionally added rinse agent.

In particular, the method comprises:

(a) contacting ware in a washing step with an aqueous cleaning composition in a ware washing machine, the aqueous cleaning composition comprising a major portion of an aqueous diluent and about 200 to 5000 parts by weight of a ware washing detergent per each one million parts of the aqueous diluent; and

(b) contacting the washed ware in a rinse step with an aqueous rinse, the aqueous rinse being substantially free of an intentionally added rinse agent, characterized in that the ware washing detergent contains a sufficient amount of a polysaccharide to provide a layer of polysaccharide on the ware so as to afford sheeting action in the aqueous rinse step.

The polysaccharide preferably constitutes 0.01% to 50% (w/w) of the detergent, more preferably 0.1% to 20% (w/w), even more preferably 0.2 to 10% (w/w), even more preferably 0.5% to 5% (w/w), most preferably 1 to 5%, based on total (wet or dry) weight of the detergent composition.

Typically, the concentration of the polysaccharide in the aqueous cleaning composition, i.e. the aqueous wash solution, is from 1 to 100 ppm, preferably from 2 to 50 ppm, more preferably from 5 to 50 ppm.

The polysaccharide typically is added to the cleaning composition as part of the detergent. However, it is also possible to add the polysaccharide to the cleaning composition as a separately formulated product. Such a separately formulated product may contain a relatively high level (even 100%) of polysaccharide. This separate product, which can be liquid or solid, may be dosed manually or automatically. This may for instance be done to boost the drying of specific substrates, for instance when washing difficult to dry plastic trays, or to solve stability issues between the polysaccharide and the main wash detergent. In this way, the level of polysaccharide in the main wash can be adjusted flexibly and independently from the main wash detergent, to provide a layer of polysaccharide on the ware so as to afford a sheeting action in the aqueous rinse step.

In the rinse step, the washed ware is contacted with an aqueous rinse. The aqueous rinse is substantially free from an intentionally added rinse agent (also called rinse aid). Preferably, no rinse agent at all is intentionally added to the aqueous rinse.

The polysaccharide is present in the ware washing detergent in a sufficient amount to provide a layer on the ware so as to afford sheeting action in the aqueous rinse step. A polysaccharide that is suitable for use in the ware washing detergent should sufficiently adsorb on a solid surface to provide overall improved drying behavior, such as reduced drying time and/or reduced remaining number of droplets, of the ware.

To determine the suitability of polysaccharides for the method of this invention, the drying behavior of a substrate is compared under identical conditions using an institutional ware washing process comprising a main wash step and a rinse step, wherein a detergent composition is used in the main wash step with or without the presence of polysaccharide, followed by a rinse step with fresh soft water, i.e. water without added rinse aid. Soft water with a water hardness of at the most one German Hardness is used for this test, both for the main wash and for the rinse.

Drying behavior is measured on 3 different types of substrates. These are coupons which typically are very difficult to dry in an institutional ware washing process without the use of rinse components. These substrates are:

2 glass coupons (148*79*4 mm)

2 plastic ('Nytralon 6E′(Quadrant Engineering Plastic Products); naturel) coupons (97*97*3 mm)

2 stainless steel cups (110*65*32 mm), model: Le Chef, supplier: Elektroblok BV.

The drying behavior is measured as drying time (seconds) and as residual amount of droplets after 5 minutes. Measurements typically are started immediately after opening the machine.

The drying behavior with polysaccharides added to the main wash can also be quantified by the drying coefficient. This can be calculated both for the drying time and the number of remaining droplets after 5 minutes and is corresponding to the ratio:
Drying time using detergent with polysaccharide
Drying time using detergent without polysaccharide and/or
Number of droplets after 5 minutes using detergent with polysaccharide
Number of droplets after 5 minutes using detergent without polysaccharide

A better drying behavior corresponds with a lower drying coefficient. Average drying coefficients are calculated as the average values for all 3 different substrates.

A polysaccharide that is suitable for use in the method of the invention provides:

an average drying coefficient based on drying time being at the most 0.9, preferably at the most 0.8, more preferably at the most 0.7, even more preferably at the most 0.6, even more preferably at the most 0.5, even more preferably at the most 0.4, most preferably at the most 0.3, as being measured under identical conditions except for presence or absence of the polysaccharide to be tested in the detergent. The lower limit of this ratio typically may be about 0.1, and/or

an average drying coefficient based on remaining number of droplets being at the most 0.5, preferably at the most 0.4, more preferably at the most 0.3, even more preferably at the most 0.2, most preferably at the most 0.1, as being measured under identical conditions except for presence or absence of the polysaccharide to be tested in the detergent. The lower limit of this ratio may be 0.

Polysaccharides that display an average drying coefficient based on drying time of >0.9 as well as an average drying coefficient based on remaining number of droplets of >0.4 typically are not appropriate for use in the method of the invention.

The concentration of the tested polysaccharide typically is 2 to 5% (w/w) in the detergent composition, and 20 to 50 ppm in the wash solution.

Care should be taken to choose such test conditions that provide proper differences in drying behavior with and without polysaccharide. For instance, those conditions are suitable that give a proper difference in drying when comparing a process with a common rinse aid added to the rinse water with a process using the same detergent (in which no polysaccharide is present) and a rinse step with fresh water. In a process without using a rinse aid in the rinse water, the substrates typically are not dried within 5 minutes, giving an average number of remaining droplets between 5 and 25, while in the process with rinse aid the average number of remaining droplets is less than half of this number. Suitable conditions are for instance those of examples 1. A common rinse aid may be a nonionic surfactant dosed at about 100 ppm in the rinse water, for instance Rinse Aid A (see example 1).

The detergent composition that may be used for this comparison typically contains phosphate, caustic and hypochlorite, e.g. 0.53 g/l sodium tripolyphosphate (STP; LV 7 ex-Rhodia)+0.44 g/l sodium hydroxide (NaOH)+0.03 g/l dichloroisocyanuric acid Na-salt.2aq (NaDCCA).

In one embodiment, the polysaccharide has a viscosity of at least 100 mPa·s, tested at 25° C. using an 1% aqueous solution of the polysaccharide. The polysaccharide is dissolved during 10 minutes at 50° C. and the viscosity is measured at 25° C. 1 hour after the 10 minutes period.

Polysaccharides

A polysaccharide according to this invention is a polymer comprising monosaccharide units linked by glycosidic linkages. The monosaccharide unit may be an aldose or a ketose of 5 or 6 carbon atoms. The polysaccharide may be a homopolysaccharide or a heteropolysaccharide, it may be linear or branched, and/or it may be chemically modified.

Suitable polysaccharides may be cellulose-based, pectin-based, starch-based, natural gum-based.

Examples of cellulose-based polysaccharides are hydroxyethylcellulose, hydrophobically modified hydroxyethylcellulose, ethyl hydroxyethyl cellulose, hydrophobically modified ethyl hydroxyethyl cellulose, hydroxypropylcellulose or sodium carboxymethylcellulose. Such cellulose-based polysaccharides are sold under the trade name Bermocoll by AkzoNobel or Natrosol, Klucel or Blanose by Aqualon-Hercules.

An example of a Starch-Based Polysaccharide Is Potato Starch

Examples of natural gum-based polysaccharides are polygalactomannans like guar gums or locust bean gums, polygalactans like carrageenans, polyglucans like xanthan gums, polymannuronates like alginate.

Preferred natural gums are based on guar. Most preferred are modified guars such as guar gum 2-hydroxypropyl ether or canonically modified guars such as Guar gum 2 hydroxy-3-(trimethylammonium)propyl ether. Suitable modified guars are sold under the trade name Jaguar by Rhodia.

Particularly preferred are the following polysaccharides: Modified guar gums, such as Guar gum, 2-hydroxypropyl ether, such as Jaguar HP 8 and Jaguar HP 105 (Rhodia); Cationically modified guar gums, such as Guar gum, 2 hydroxy-3-(trimethylammonium) propyl ether chloride such as Jaguar C 17 and Jaguar C 1000 (Rhodia); Xanthan gums such as Rhodopol G (Rhodia); Cellulose-based polysaccharides such as Hydroxyethylcellulose such as Natrosol HEC 250 HHX (Aqualon-Hercules); Hydrophobically modified hydroxyethylcellulose such as Natrosol HEC Plus 330 CS (Aqualon-Hercules); Ethyl hydroxyethyl cellulose such as Bermocoll E 511 X and Bermocoll EBS 351 FQ (AkzoNobel); Hydrophobically modified ethyl hydroxyethyl cellulose such as Bermocoll EHM 500 (AkzoNobel); Hydroxypropylcellulose such as Klucel EF (Aqualon-Hercules); Sodium carboxymethylcellulose such as Blanose 7 MF Pharm (Aqualon-Hercules); and Starches such as Potato starch (Sigma).

These polysaccharides can be used alone or in combination with other polysaccharides or with polymeric or nonionic surfactants as described in WO2006/119162 in the detergent composition.

Cationic polymers, such as the Jaguar polymers, may be combined with certain anions, such as silicate, phosphonate, phosphate, hydroxide and/or citrate anions. Both for liquid and solid detergents, properties like drying performance and product stability can be influenced by the type of anion and the order of addition of the detergent components when making these products.

Detergent Composition

In addition to the ingredients described herein above, the detergent compositions may comprise conventional ingredients, preferably selected from alkalinity sources, builders (i.e. detergency builders including the class of chelating agents/sequestering agents), bleaching systems, anti-sealants, corrosion inhibitors, surfactants, antifoams and/or enzymes. Suitable caustic agents include alkali metal hydroxides, e.g. sodium or potassium hydroxides, and alkali metal silicates, e.g. sodium metasilicate. Especially effective is sodium silicate having a mole ratio of SiO₂:Na₂O of from about 1.0 to about 3.3, preferably from about 1.8 to about 2.2, normally referred to as sodium disilicate. The pH of the detergent composition typically is in the alkaline region; preferably >9, more preferably >10.

Builder Materials

Suitable builder materials (phosphates and non-phosphate builder materials) are well known in the art and many types of organic and inorganic compounds have been described in the literature. They are normally used in all sorts of cleaning compositions to provide alkalinity and buffering capacity, prevent flocculation, maintain ionic strength, extract metals from soils and/or remove alkaline earth metal ions from washing solutions.

The builder material usable herein can be any one or mixtures of the various known phosphate and non-phosphate builder materials. Examples of suitable non-phosphate builder materials are the alkali metal citrates, carbonates and bicarbonates; and the salts of nitrilotriacctic acid (NTA); methylglycine diacetic acid (MGDA); glutaric diacetic acid (GLDA), polycarboxylates such as polymaleates, polyacetates, polyhydroxyacrylates, polyacrylate/polymaleate and polyacrylate/polymethacrylate copolymers, as well as zeolites; layered silicas and mixtures thereof. They may be present (in % by wt.), in the range of from 1 to 70, and preferably from 5 to 60, more preferably from 10 to 60.

Particularly preferred builders are phosphates, NTA, EDTA, MGDA, GLDA, citrates, carbonates, bicarbonates, polyacrylate/polymaleate, maleic anhydride/(meth)acrylic acid copolymers, e.g. Sokalan CP5 available from BASF.

Antisealants

Scale formation on dishes and machine parts can be a significant problem. It can arise from a number of sources but, primarily it results from precipitation of either alkaline earth metal carbonates, phosphates or silicates. Calcium carbonate and phosphates are the most significant problem. To reduce this problem, ingredients to minimize scale formation can be incorporated into the composition. These include polyacrylates of molecular weight from 1,000 to 400,000 examples of which are supplied by Rohm & Haas, BASF and Alco Corp. and polymers based on acrylic acid combined with other moieties. These include acrylic acid combined with maleic acid, such as Sokalan CP5 and CP7 supplied by BASF or Acusol 479N supplied by Rohm & Haas; with methacrylic acid such as Colloid 226/35 supplied by Rhone-Poulenc; with phosphonate such as Casi 773 supplied by Buckman Laboratories; with maleic acid and vinyl acetate such as polymers supplied by Huls; with acrylamide; with sulfophenol methallyl ether such as Aquatreat AR 540 supplied by Alco; with 2-acrylamido-2-methylpropane sulfonic acid such as Acumer 3100 supplied by Rohm & Haas or such as K-775 supplied by Goodrich; with 2-acrylamido-2-methylpropane sulfonic acid and sodium styrene sulfonate such as K-798 supplied by Goodrich; with methyl methacrylate, sodium methallyl sulfonate and sulfophenol methallyl ether such as Alcosperse 240 supplied by Alco; polymaleates such as Belclene 200 supplied by FMC; polymethacrylates such as Tamol 850 from Rohm & Haas; polyaspartates; ethylenediamine disuccinate; organo polyphosphonic acids and their salts such as the sodium salts of aminotri(methylenephosphonic acid) and ethane 1-hydroxy-1,1-diphosphonic acid. The anti-sealant, if present, is included in the composition from about 0.05% to about 10% by weight, preferably from 0.1% to about 5% by weight, most preferably from about 0.2% to about 5% by weight.

Surfactants

Surfactants and especially nonionics may be present to enhance cleaning and/or to act as defoamer. Typically used nonionics are obtained by the condensation of alkylene oxide groups with an organic hydrophobic material which may be aliphatic or alkyl aromatic in nature, e.g. selected from the group consisting of a C2-C18 alcohol alkoxylate having EO, PO, BO and PEO moieties or a polyalkylene oxide block copolymer.

The surfactant may be present in a concentration of about 0% to about 10% by weight, preferably from 0.5% to about 5% by weight, most preferably from about 0.2% to about 2% by weight. Due to the effect of the polysaccharide as described herein, the surfactant level in detergent formulations may be lowered to at the most 2% by weight.

Bleaches

Suitable bleaches for use in the system according the present invention may be halogen-based bleaches or oxygen-based bleaches. More than one kind of bleach may be used.

As halogen bleach, alkali metal hypochlorite may be used. Other suitable halogen bleaches are alkali metal salts of di- and tri-chloro and di- and tri-bromo cyanuric acids. Suitable oxygen-based bleaches are the peroxygen bleaches, such as sodium perborate (tetra- or monohydrate), sodium carbonate or hydrogen peroxide.

The amounts of hypochlorite, di-chloro cyanuric acid and sodium perborate or percarbonate preferably do not exceed 15%, and 25% by weight, respectively, e.g. from 1-10% and from 4-25% and by weight, respectively.

Enzymes

Amylolytic and/or proteolytic enzymes would normally be used as an enzymatic component. The amylolytic enzymes usable herein can be those derived from bacteria or fungi.

Minor amounts of various other components may be present in the chemical cleaning system. These include solvents, and hydrotropes such as ethanol, isopropanol and xylene sulfonates, flow control agents; enzyme stabilizing agents; anti-redeposition agents; corrosion inhibitors; and other functional additives.

Components of the detergent composition may independently be formulated in the form of solids (optionally to be dissolved before use), aqueous liquids or non-aqueous liquid (optionally to be diluted before use).

The ware washing detergent may be in the form of a liquid or a powder. The powder may be a granular powder. When in powder form, a flow aid may be present to provide good flow properties and to prevent lump formation of the powder. The detergent preferably may be in the form of a tablet or a solid block. Also preferably, the detergent may be a combination of powder and tablet in a sachet, to provide a unit dose for several washes. The liquid may be a conventional liquid, structured liquid or gel form.

The polysaccharide can be incorporated rather easily in main wash detergents like tablets, blocks, powders or granules without sacrificing physical properties like flow and stability. The polysaccharide, incorporated in the wash detergent, can be in a liquid form, but also in solid form.

The chemical cleaning method may be utilized in any of the conventional automatic institutional or domestic ware washing processes.

Typical institutional ware washing processes are either continuous or non-continuous and are conducted in either a single tank or a multi-tank/conveyor type machine. In the conveyor system pre-wash, wash, post-rinse and drying zones are generally established using partitions. Wash water is introduced into the rinsing zone and is passed cascade fashion back towards the pre-wash zone while the dirty dishware is transported in a counter-current direction.

Typically, an institutional warewash machine is operated at a temperature of between 45-65° C. in the washing step and about 80-90° C. in the rinse step. The washing step typically does not exceed 10 minutes, or even does not exceed 5 minutes. In addition, the aqueous rinse step typically does not exceed 2 minutes.

It is envisaged to dose the detergent in the ware washing process in a concentrated version, e.g. using about 10% of the common amount of aqueous diluent, and to add the remaining 90% of the aqueous diluent in a later stage of the washing process, e.g. after 10 to 30 seconds contact time of the ware with the concentrated detergent, such as performed in the Divojet® concept of JohnsonDiversey.

It is also envisaged to use the ware washing detergent for periodically treating the ware. A treatment using a detergent comprising polysaccharide as described herein may be alternated with one or more washings using a detergent without polysaccharide. Such a periodic treatment may be done with a relatively high concentration of polysaccharide in the detergent, providing e.g. 50 to 500 ppm polysaccharide in the wash solution.

Surprisingly, it was found that the cleaning method using a detergent comprising a polysaccharide as described herein also performs very well in domestic ware washing processes. Even under domestic ware washing conditions, where the rinse step is substantially longer as compared to institutional processes, the polysaccharide as described herein provided a layer on the ware so as to afford a sheeting action in the aqueous rinse step.

The detergent comprising a polysaccharide as described herein also performs very well when soft water, or even reverse osmosis water, is used in the rinse step, and optionally also in the wash step. Reverse osmosis water is often used for warewashing when high visual appearance of substrates, especially glasses, is important, because this type of water leaves no water residues. However, using standard rinse aids can have a negative effect on visual appearance (because of non-ionic residues), or spots can be formed when drying is not perfect.

With this concept of built-in rinse aid, a simpler wash process is obtained for institutional and domestic ware washing, which eliminates the need for using a separate rinse aid. Besides increased simplicity, this concept provides clear cost savings, like for raw materials, packaging, processing, transport and storage of the separate rinse aid, but also by eliminating the need for a pump to dose the rinse aid into the rinse solution.

The optimal drying behaviour obtained by the built-in rinse aid concept with polysaccharides may also reduce the electrostatic properties of the substrates.

The polysaccharide which provides optimal drying properties in this concept of built-in rinse aid for ware washing processes can have some cleaning, defoaming, builder, binder, rheology modifying, thickening, structuring, scale preventing or corrosion inhibiting properties as well and so improve the overall wash process. In particular, a reduced scale build up was observed as compared to a similar system without built-in rinse aid and rinsing with water only. In addition, no effect on beer foam properties was observed as compared to a standard rinse process where nonionics from the rinse aid left behind on the glasses typically suppress the foam. Also, a positive soil release effect on fatty type of soils was observed.

This invention will be better understood from the Examples which follow. However, one skilled in the art will readily appreciate that the specific methods and results discussed are merely illustrative of the invention and no limitation of the invention is implied.

### Example 1

In this example the drying behavior of various substrates is tested in an institutional single tank warewash machine. A standard institutional wash process with soft water is applied for this test with a main wash process containing phosphate, caustic and hypochlorite.

First (test 1 A) the drying behavior of this process with a standard rinse process is determined. In this standard rinse process a rinse aid is dosed in the separate rinse.

Then (test 1 B: reference) the drying behavior is determined for a wash process in which no rinse components are present (not dosed via the separate rinse and not added to the main wash process). In this case, the mainwash contains only the main wash powder (phosphate, caustic and hypochlorite) and the rinse is done with fresh soft water.

Then (tests 1 C up to 1 Y) the drying behavior is determined for various wash processes in which no rinse component is dosed in the separate rinsed (so rinsed only with fresh soft water) but where different components are added to the main wash together with the other main wash components.

In test 1 C up to 1H, these components are surfactants which are described in example 8 of patent application WO 2006119162. Materials from this example 8 (from patent application WO 2006119162) were selected because the conditions for drying substrates in that example are most demanding. Relatively low temperature of main wash (50 degrees C.) and rinse (80 degrees C.) and relatively short main wash cycle (29 sec.) were applied; these conditions will lead to minimal heating up of the substrates and so drying is determined especially by components adsorbed during the main wash. Furthermore, a relatively high rinse volume (4 L) is applied, which implies that only surfactants which are adsorbed strongly onto the substrates will lead to proper drying of these substrates.

Those surfactants which provided best drying results in tap water (in this example 8 from patent application WO 2006119162) were selected and tested now in soft water. The same stringent conditions are used in this test and applied to substrates which are very difficult to dry.

In test 1 I up to 1 Y the drying behavior is determined, under the same stringent conditions in soft water, for a number of polysaccharides.

The materials used as surfactant in test 1 C up to 1 H are: Plurafac LF 300 (tests 1 C, 1 D and 1 E), ex BASF, fatty alcohol alkoxylate; Sokalan CP5 (test 1 C), ex BASF, maleic acid/acrylic acid copolymer, Na-salt (Mw 70000); Versaflex SI (test 1 D), ex Alco, acrylic copolymer; Alcosperse 175 (test 1 E), ex Alco, maleic/acrylic acid copolymer (Mw 75000); Sokalan CP9 (tests 1 F), ex BASF, maleic acid/olefin-copolymer, Na-salt (Mw 12000); Casein (test 1 G), ex Aldrich (technical grade); Inutec SP1 (test 1H), ex Orafti, hydrophobically modified (with C12 alkylchains) inulin (Mw 5000).

The materials used as polysaccharides in test 1 I up to 1 Y are: Bermocoll EHM 500 (test 1 I), ex AkzoNobel, Hydrophobically modified ethyl hydroxyethyl cellulose; Bermocoll E 511 X (test 1 J), ex AkzoNobel, Ethyl hydroxyethyl cellulose (high viscosity grade); Bermocoll EBS 351 FQ (test 1 K), cx AkzoNobel, Ethyl hydroxyethyl cellulose (medium viscosity grade); Rhodopol G (test 1 L), ex Rhodia, Xanthan gum (CAS nr. 11138-66-2); Meyprodor 50 (test 1 M), ex Danisco, Guar Gum; Grindsted Carrageenan CP120 (test 1 N), ex Danisco, Blend of carrageenan and locust bean gum; Jaguar HP 8 (test 1 O), ex Rhodia, Guar gum, 2-hydroxypropyl ether (CAS Nr: 39421-75-5); Jaguar HP 105 (test 1 P), ex Rhodia, Guar gum, 2-hydroxypropyl ether (CAS Nr: 39421-75-5); Jaguar C 17 (test 1 Q), ex Rhodia, Guar gum, 2 hydroxy-3-(trimethylammonium)propyl ether chloride (CAS Nr: 65497-29-2); Jaguar C 1000 (test 1 R), ex Rhodia, Gomme de Guar, oxydee, 2-hydroxy-3-(trimethylammonio) propyl ether chlorure (CAS Nr: 71888-88-5); Klucel EF (test 1 S), ex Aqualon-Hercules, Hydroxypropylcellulose (CAS Number 9004-64-2); Blanose 7 MF Pharm (test 1 T), ex Aqualon-Hercules, High purity sodium carboxymethylcellulose, sodium CMC, 99.5% minimum (CAS Number 9004-32-4); Natrosol HEC 250 HEX (test 1 U), ex Aqualon-Hercules, Hydroxyethylcellulose (CAS Number 9004-62-0); Natrosol HEC Plus 330 CS (test 1 V), ex Aqualon-Hercules, Modified hydroxyethylcellulose (CAS Number 80455-45-4); Grinsted Alginate FD 460 (test 1 W), ex Danisco, Calcium alginate; Grindsted Pectin LA 210 (test 1 X), ex Danisco, Pectin; Potato starch (test 1 Y); ex Sigma.

In the table below the concentrations of these materials in the mainwash solutions for each of the components are mentioned. These levels implicate that the detergent contains about 2 to 5 wt-% surfactant or polysaccharide in these various examples.

The warewasher used for these tests is a Hobart-single tank hood machine, which is automated for laboratory testing, such that the hood is opened and closed automatically and the rack with ware is transported automatically into and out off the machine.

Specifications Single Tank Hood Machine

Type: Hobart AUX70E

Volume washbath: 50 L

Volume rinse: 4 L

Wash time: 29 seconds

Rinse time: 8 seconds

Wash temperature: 50° C.

Rinse temperature: 80° C.

Water: soft water (water hardness: <1 DH).

Process

When the wash bath is filled with soft water and heated up, the wash program is started. The washwater will be circulated in the machine by the internal wash pump and the wash arms over the dishware. When the wash time is over, the wash pump will stop and the wash water will stay in the reservoir below the substrates. Then 4 L of the wash bath will be drained automatically by a pump into the drain. Then the rinse program will start; fresh warm water from the boiler (connected to the soft water reservoir) will be rinsed by the rinse arms over the dishware. When the rinse time is over the machine is opened.

It should be noticed that (in contrast to consumer type of dishwash machines) only fresh soft water is rinsed over the substrates: no components from the main wash process can dissolve in the rinse water. The wash pump and wash arms and nozzles are not used for rinsing and the rinse water is not circulating in the wash tank during rinsing.

Working Method

Once the machine is filled with soft water and temperature of water is 50° C., the main wash powder (and components to be tested) are added via a plate on the rack. One wash cycle is done to be sure that the product is totally dissolved. When needed, a defoamer was added to the main wash solution to prevent foam formation. Main wash powder is: 0.53 g/l sodium tripoly phosphate (STP; LV 7 ex-Rhodia)+0.44 g/l sodium hydroxide (NaOH)+0.03 g/l dichloroisocyanuric acid Na-salt. 2aq (NaDCCA).

Drying times are measured on 3 different types of substrates. These substrates are selected because they are difficult to dry in an institutional warewash process without rinse components and only moderately dried with a standard rinse aid process. These substrates are made of the following, practically relevant, materials: 2 glass coupons (148*79*4 mm); 2 plastic (‘Nytralon 6E’(Quadrant Engineering Plastic Products); nature]) coupons (97*97*3 mm); 2 stainless steel cups (110*65*32 mm), model: Le Chef, supplier: Elektroblok BV.

After the wash cycle (29 seconds) and rinse cycle (8 seconds with fresh soft water) the drying time is determined (in seconds) of the washed substrates at ambient temperature. When drying time is longer than 300 s, it is reported as 300 s. However, many of the substrates are not dried within five minutes. In that case, the remaining droplets on the substrates are also counted.

The wash cycle and drying time measurements are repeated two more times with the same substrates without adding any chemicals. The substrates are replaced for every new test (in order not to influence the drying results by components possibly adsorbed onto the ware).

Results

The table below compiles the results of these tests series. For the stainless steel substrates, glass and plastic coupons both the average values of the drying times and the average values of the number of droplets on the coupons after five minutes for the 3 repeat tests are given.

In test 1A the drying effects are measured for a representative standard institutional dish wash process in which drying of the substrates is obtained by rinsing with a rinse solution in which rinse aid is dosed. These rinse components are dosed via a separate rinse pump just before the boiler into the last rinse water. Three wash cycles are done before the test starts, in order to be sure that the rinse aid is homogenously distributed through the boiler.

In this example Rinse Aid A is used as representative rinse aid for institutional ware washing. This neutral rinse aid contains about 30% of a non-ionic mixture. By dosing this rinse aid at a level of 0.3 g/L, the concentration of non-ionics in the rinse solution is about 90 ppm. Key components of Rinse Aid A are given in the Table below.

| As | | |
|---|---|---|
| supplied | Raw material | Trade name |
| 22.5% | Alcohol (C13-15) alkoxylate (EO/BO) (95%) | Plurafac LF221 |
| 7.5% | Alcohol alkoxylate (EO/PO) | Plurafac LF403 |
| 5.0% | Cumene sulphonic acid Na-salt (40%) | Eltesol SC40 |
| 65.0% | Water | Water |

The results of test 1A confirm that indeed these substrates are difficult to dry. Under these current standard wash and rinse conditions, only the glass coupons get dried, while on the plastic and stainless steel substrates still several water droplets are left behind after 5 minutes.

But this drying with standard separate rinse is much better than for a process without any rinse components; test 1B. This reference test 1B shows that on all selected substrates many droplets are left behind, even after 5 minutes, when no rinse aid is used in the wash process.

Test 1 C up to 1 H show that the presence of the selected surfactants in the main wash have a slight positive effect on drying of glass coupons and a very minor effect on the drying behavior of stainless steel and plastic. These drying results are significantly worse than for drying by standard separate rinse aid under the same conditions in soft water. These drying results are also worse than the results obtained with the same components in tap water as described in example 8 from patent application WO 2006119162. Obviously, interaction with water hardness ions is needed for these components to provide drying properties in this ware washing process.

However, test 1 I up to 1 Y show that several polysaccharides provide good drying under the same conditions in soft water. The presence of various polysaccharides at relatively low levels in the main wash can reduce drying times or the number of remaining droplets on stainless steel, glass and plastic significantly. Some of these drying behaviors are comparable or even better than for using a separate rinse aid. Especially the cationic guars Jaguar C 17 and Jaguar C 1000 provide excellent drying properties under these conditions, where is rinsed with fresh soft water only.

Drying Results for Different Components Added to the Main Wash

| | | | Stainless steel | | Glass | | Plastic | |
|---|---|---|---|---|---|---|---|---|
| All tests added to main wash: 530 ppm | | | Time; | Drop- | Time; | Drop- | Time; | Drop- |
| STPP + 440 ppm NaOH + 30 ppm NaDCCA | | | Sec. | lets # | Sec. | lets # | Sec. | lets # |
| 1 A | No other components added to main | | 300 | 10 | 118 | 0 | 299 | 3 |
| | wash; separate rinse aid A; 0.3 g/L. | | | | | | | |
| 1 B | No other components added to main | | 300 | 21 | 300 | 5 | 300 | 24 |
| | wash: reference test | | | | | | | |
| | Surfactant added to main wash | | | | | | | |
| 1 C | Plurafac LF300 20 ppm | Sokalan CP5 30 ppm | 300 | 18 | 247 | 0 | 300 | 21 |
| 1 D | Plurafac LF300 10 ppm | Versaflex SI 40 ppm | 300 | 22 | 231 | 1 | 300 | 22 |
| 1 E | Plurafac LF300 10 ppm | Alcosperse 175 40 ppm | 300 | 18 | 215 | 1 | 300 | 23 |
| 1 F | | Sokalan CP9 20 ppm | 300 | 18 | 218 | 2 | 300 | 29 |
| 1 G | | Casein 50 ppm | 300 | 16 | 277 | 1 | 300 | 23 |
| 1 H | | Inutec SP1 50 ppm | 300 | 19 | 250 | 1 | 300 | 18 |

| | Polysaccharide added to main wash | | | | | | | |
|---|---|---|---|---|---|---|---|---|
| 1 I | Bermocoll EHM 500 | 30 ppm | 300 | 8 | 285 | 1 | 295 | 3 |
| 1 J | Bermocoll E 511 X | 30 ppm | 300 | 4 | 268 | 1 | 300 | 6 |
| 1 K | Bermocoll EBS 351 FQ | 30 ppm | 300 | 6 | 286 | 2 | 300 | 7 |
| 1 L | Rhodopol G | 50 ppm | 300 | 10 | 136 | 0 | 300 | 11 |
| 1 M | Meyprodor 50 | 50 ppm | 300 | 9 | 266 | 1 | 300 | 16 |
| 1 N | Grind. Carrageenan CP120 | 50 ppm | 300 | 9 | 238 | 1 | 300 | 17 |
| 1 O | Jaguar HP 8 | 20 ppm | 300 | 12 | 226 | 0 | 300 | 11 |
| 1 P | Jaguar HP 105 | 20 ppm | 290 | 3 | 153 | 0 | 300 | 8 |
| 1 O | Jaguar C 17 | 20 ppm | 107 | 0 | 44 | 0 | 148 | 1 |
| 1 R | Jaguar C 1000 | 30 ppm | 73 | 0 | 40 | 0 | 232 | 1 |
| 1 S | Klucel EF | 50 ppm | 300 | 4 | 146 | 0 | 300 | 8 |
| 1 T | Blanose 7 MF Pharm | 50 ppm | 300 | 14 | 104 | 0 | 300 | 21 |
| 1 U | Natrosol HEC 250 HHX | 50 ppm | 290 | 2 | 100 | 0 | 300 | 2 |
| 1 V | Natrosol HEC Plus 330 CS | 30 ppm | 227 | 1 | 128 | 0 | 280 | 3 |
| 1 W | Grinsted Alginate FD 460 | 50 ppm | 300 | 18 | 251 | 0 | 300 | 12 |
| 1 X | Grindsted Pectin LA 210 | 50 ppm | 300 | 17 | 208 | 0 | 300 | 12 |
| 1 Y | Potato starch | 50 ppm | 300 | 15 | 120 | 0 | 300 | 15 |

Drying Coefficient

The drying behavior of these components added to the main wash can also be quantified by the drying coefficient. This can be calculated both for the drying time and the number of remaining droplets after 5 minutes and is corresponding to the ratio:
Drying time using detergent with added component
Drying time using detergent without added component (reference test 1B) and/or
Number of droplets after 5 minutes using detergent with added component
Number of droplets after 5 minutes using detergent without added component

A better drying behavior corresponds with a lower drying coefficient.

In the table below the drying coefficients are calculated for the various wash processes. The drying coefficients are calculated as the average value for all 3 different substrates. In the same way, the drying coefficients are calculated for the wash process with standard separate rinse aid (test 1A).

Average Drying Coefficients

| | | | Drying Coefficient | |
|---|---|---|---|---|
| | | | | Number of |
| All tests added to main wash: 530 ppm | | | Drying | remaining |
| STPP + 440 ppm NaOH + 30 ppm NaDCCA | | | time | droplets |
| 1 A | No other components added to main wash; | | 0.80 | 0.20 |
| | separate rinse aid A; 0.3 g/L. | | | |
| 1 B | No other components added to main wash: | | — | — |
| | reference test. | | | |
| | Surfactant added to main wash | | | |
| 1 C | Plurafac LF300 20 ppm | Sokalan CP5 30 ppm | 0.94 | 0.58 |
| 1 D | Plurafac LF300 10 ppm | Versaflex SI 40 ppm | 0.92 | 0.72 |
| 1 E | Plurafac LF300 10 ppm | Alcosperse 175 40 ppm | 0.90 | 0.67 |
| 1 F | | Sokalan CP9 20 ppm | 0.91 | 0.82 |
| 1 G | | Casein 50 ppm | 0.97 | 0.64 |
| 1 H | | Inutec SP1 50 ppm | 0.94 | 0.62 |
| | Polysaccharide added to main wash | | | |
| 1 I | Bermocoll EHM 500 | 30 ppm | 0.98 | 0.24 |
| 1 J | Bermocoll E 511 X | 30 ppm | 0.98 | 0.21 |
| 1 K | Bermocoll EBS 351 FQ | 30 ppm | 0.98 | 0.33 |
| 1 L | Rhodopol G | 50 ppm | 0.82 | 0.31 |
| 1 M | Meyprodor 50 | 50 ppm | 0.96 | 0.43 |
| 1 N | Grind. Carrageenan CP120 | 50 ppm | 0.93 | 0.45 |
| 1 O | Jaguar HP 8 | 20 ppm | 0.92 | 0.34 |
| 1 P | Jaguar HP 105 | 20 ppm | 0.82 | 0.16 |
| 1 Q | Jaguar C 17 | 20 ppm | 0.33 | 0.01 |
| 1 R | Jaguar C 1000 | 30 ppm | 0.38 | 0.01 |
| 1 S | Klucel EF | 50 ppm | 0.83 | 0.17 |
| 1 T | Blanose 7 MF Pharm | 50 ppm | 0.78 | 0.51 |
| 1 U | Natrosol HEC 250 HHX | 50 ppm | 0.77 | 0.06 |
| 1 V | Natrosol HEC Plus 330 CS | 30 ppm | 0.71 | 0.06 |
| 1 W | Grinsted Alginate FD 460 | 50 ppm | 0.95 | 0.45 |
| 1 X | Grindsted Pectin LA 210 | 50 ppm | 0.90 | 0.44 |
| 1 Y | Potato starch | 50 ppm | 0.80 | 0.61 |

These drying coefficients confirm the good to excellent drying properties of polysaccharides added to the main wash. For all examples the drying coefficient based on remaining droplets is at the most 0.5 and/or the drying coefficient based on drying time is at the most 0.9, while this is not the case for the drying coefficients for the surfactants added to the main wash.

### Example 2

The viscosity of aqueous solutions containing 1% of the components tested as main wash additions in example 1 is measured.

The samples were prepared by adding 1 g of the polysaccharide to 99 g of soft water and mixing vigorously. Meanwhile, the mixture was heated to 50° C. and mixed for 10 minutes at 50° C. The mixture was allowed to cool down to room temperature and the viscosity was measured after 1 hour using a Haake VT 500 equipped with a spindle MV2 at a shear rate of 21 s-1 at 25° C. The results are given in the table below.

| | Viscosity (mPa · s) |
|---|---|
| Surfactant | |
| Plurafac LF300 | 28 |
| Sokalan CP5 | 8 |
| Versaflex SI | 10 |
| Alcosperse 175 | 16 |
| Sokalan CP9 | 43 |
| Casein | 8 |
| Inutec SP1 | 71 |
| Polysaccharide | |
| Bermocoll EHM 500 | 1660 |
| Bermocoll E 511 X | 915 |
| Bermocoll EBS 351 FQ | 304 |
| Rhodopol G | 1350 |
| Meyprodor 50 | 593 |
| Grind. Carrageenan CP120 | 145 |
| Jaguar HP 8 | 1950 |
| Jaguar HP 105 | 1970 |
| Jaguar C 17 | 963 |
| Jaguar C 1000 | 133 |
| Klucel EF | 14 |
| Blanose 7 MF Pharm | 155 |
| Natrosol HEC 250 HHX | 1300 |
| Natrosol HEC Plus 330 CS | 440 |
| Grinsted Alginate FD 460 | 27 |
| Grindsted Pectin LA 210 | 33 |

It is remarkable that almost all polysaccharides, providing good drying in soft water (example 1), also lead to much higher viscosities than the surfactants which give poor drying in soft water (example 1).

### Example 3

In this example the drying behavior of various substrates is tested in a domestic warewash machine. A standard wash process with tap water is applied for this test with a main wash process containing phosphate and metasilicate.

First (test 1) the drying behavior of this process without any rinse component is determined. In this reference test no rinse component was present in the main wash solution and no rinse component was added to the last rinse with water.

Then (test 2) the drying behavior is determined for a wash process in which a polysaccharide (cationic guar) was present in the main wash and no rinse component was dosed in the last rinse with water.

The warewasher used for these tests is a Blomberg GS 13240. Tap water, with a water hardness of 5 German Hardness, was used for these tests. The automated Eco-process was applied for these tests. This process starts with a wash process of about 40 minutes, the wash solution, is heated to about 50 degrees C.; followed by the last rinse process of about 20 minutes with fresh water; followed by a drying step of about 5 minutes.

Similar coupons as described in example 1 are used for these tests. These coupons are placed in the rack at the start of the test and evaluated at the end of the wash process, in the same way as described in example 1.

The composition of the detergent in test 1 is: 1.0 g/l sodium tripoly phosphate (STPP)+0.90 g/l sodium metasilicate.5aq (SMS.5Aq.).

The composition of the detergent in test 2 is: 1.0 g/l sodium tripoly phosphate+0.90 g/l sodium metasilicate.5aq.+0.1 g/L Jaguar C 1000.

These powder based detergents are added manually into the wash tank.

Drying Results in a Domestic Warewashmachine

| | | Stainless steel | | Glass | | Plastic | |
|---|---|---|---|---|---|---|---|
| Both tests added to main wash: 1000 ppm | | Time; | Drop- | Time; | Drop- | Time; | Drop- |
| STPP + 900 ppm SMS.5Aq. | | Sec. | lets # | Sec. | lets # | Sec. | lets # |
| 1 | Reference test: no other components | 300 | 11 | 120 | 0 | 300 | 14 |
| 2 | As 1: Plus 100 ppm Jaguar C 1000 | 35 | 0 | 60 | 0 | 90 | 0 |

Reference test 1 shows that the substrates are not dried properly when no rinse components are present in the wash process or in the final rinse. Test 2 shows that the presence of Jaguar C 1000 in the main wash leads to significantly faster drying. It can be concluded that a main wash detergent containing polysaccharide also provides proper drying under these conditions in a domestic ware washing process.

### Example 4

In this example the drying behaviour is tested for a powder based detergent containing one of the preferred polysaccharides from example 1: Jaguar C 1000. The following polysaccharide containing product (PS-product) was made by adding the raw materials in given order:

| order | Raw material | As supplied |
|---|---|---|
| 1 | Sodium meta silicate 0 aq | 35% |
| 2 | Water | 1% |
| 3 | Jaguar C1000 (ex Rhodia) | 2.5% |
| 4 | Sodium hydroxide (micro pearls) | 10% |
| 5 | Neosyl GP (ex Ineos silicas) | 0.5% |
| 6 | Sodium tripoly phosphate (LV 7 ex Rhodia) | 48% |
| 7 | Dichloroisocyanuric acid Na-salt 2 aq | 3% |

The water (1%) was added by spraying. By this processing method, the Jaguar C 1000 is primarily attached to the sodium meta silicate, which prevents segregation of this fine powder in this PS-product.

The following reference product (without polysaccharide) was made:

| order | Raw material | As supplied |
|---|---|---|
| 1 | Sodium meta silicate 0 aq | 35% |
| 2 | Water | 1% |
| 3 | Sodium hydroxide (micro pearls) | 10% |
| 4 | Neosyl GP (ex Ineos silicas) | 0.5% |
| 5 | Sodium tripoly phosphate (LV 7 ex Rhodia) | 50.5% |
| 6 | Dichloroisocyanuric acid Na-salt 2 aq | 3% |

Drying tests were carried out with the same test method as described in example 1. Each of the powder based products were dosed at 1 g/L and tap water, with a water hardness of 8 German Hardness, was used for these tests. The rinse was done with fresh tap water only. The drying performance was measured with similar coupons as described in example 1 leading to the following results:

Drying Results for Powder Based Products

| | Stainless steel | | Glass | | Plastic | |
|---|---|---|---|---|---|---|
| | Time | Drop- | Time | Drop- | Time | Drop- |
| Product | sec. | lets # | sec. | lets # | sec. | lets # |
| Reference | 300 | 29 | 300 | 4 | 300 | 27 |
| Product | | | | | | |
| PS-product | 247 | 7 | 34 | 0 | 300 | 9 |

The following average drying coefficients can be calculated (as described in example 1):

Drying Coefficient

| | Drying time | Number of remaining droplets |
|---|---|---|
| PS-product | 0.65 | 0.19 |

This example confirms that this physically stable powder based product containing polysaccharide provides very good drying properties when applied in the main wash of a ware washing process, where is rinsed with fresh tap water only.

### Example 5

In this example the drying behaviour is tested for a liquid based detergent containing one of the preferred polysaccharides from example 1: Jaguar C 1000. The following polysaccharide containing product (PS-liquid detergent) was made by adding the raw materials in given order:

‘PS-liquid detergent’

| | | |
|---|---|---|
| order | Raw material | % |

| | | |
|---|---|---|
| 1 | Soil water | 26.45% |
| 2 | Jaguar C 1000 (ex Rhodia) | 0.5% |
| 3 | Dequest 2000 (50% Amino tri (methylene | 2% |
| | phosphonic acid), ex Thermphos) | |
| 4 | Rhodopol G (Xanthan Gum ex Rhodia) | 0.05% |
| 5 | Caustic soda (50% NaOH solution) | 20% |
| 6 | Trilon A liquid (40% NTA-Na3 ex BASF) | 51% |

Rhodopol G was added to improve physical stability of this liquid detergent. This raw material was first predispersed with a small part of the water and then added.

The following reference liquid detergent (without polysaccharide) was made:

| order | Raw material | % |
|---|---|---|
| 1 | Soft water | 27% |
| 2 | Dequest 2000 (ex Thermphos) | 2% |
| 3 | Caustic soda (50% NaOH solution) | 20% |
| 4 | Trilon A liquid (40% NTA-Na3 ex BASF) | 51% |

Drying tests were carried out with the same test method as described in example 1. Each of the liquid based products were dosed at 1 g/L and soft water was used for these tests. The rinse was done with fresh soft water only. This lead to the following results:

Drying Results for Liquid Based Products

| | Stainless steel | | Glass | | Plastic | |
|---|---|---|---|---|---|---|
| | Time | Drop- | Time | Drop- | Time | Drop- |
| Product | sec. | lets # | sec. | lets # | sec. | lets # |
| Reference liquid | 300 | 25 | 300 | 3 | 300 | 17 |
| detergent | | | | | | |
| PS-liquid | 146 | 0 | 133 | 0 | 290 | 2 |
| detergent | | | | | | |

The following average drying coefficients can be calculated:

| | Drying Coefficient | |
|---|---|---|
| | Drying time | Number of remaining droplets |
| PS-liquid detergent | 0.63 | 0.04 |

This example confirms that this liquid based product containing polysaccharide provides very good drying properties when applied in the main wash of a ware washing process, where is rinsed with fresh water only.

The reference liquid detergent is a standard liquid detergent with very good cleaning performance. Additional cleaning trials showed that ‘PS-liquid detergent’ has similar very good cleaning performance as the reference liquid detergent on various substrates covered with various soils. So, it might be concluded that no special surfactants are needed for obtaining both proper drying and cleaning of the substrates.

### Example 6

In this example the drying behaviour is tested for a powder based detergent containing the polysaccharide Jaguar C 1000 in an institutional single tank warewash machine. In this test reverse osmosis (RO) water is applied in the main wash and in the rinse. The same dishwashing machine, wash process and working method is used as described in example 1, but now with reverse osmosis water in main wash and the rinse.

First (reference test 6A) the drying behavior is determined for a wash process in which no rinse components are present (not dosed via the separate rinse and not added to the main wash process). In this case, the mainwash contains the following main wash powder: 0.40 g/l sodium tripoly phosphate (STP; LV 7 ex-Rhodia)+0.40 g/l sodium metasilicate 5 Aq.+0.03 g/l dichloroisocyanuric acid Na-salt. 2aq (NaDCCA).

Then (test 6B) the drying behaviour of this process with a standard rinse process is determined. In this standard rinse process, rinse aid A (the same as in example 1) is dosed in the rinse flow.

Then (test 6C) the drying behavior is determined for a wash processes in which no rinse component is dosed in the rinse flow (so rinsed only with fresh RO-water) but where 0.015 g/L Jaguar C1000 was added to the main wash together with the other main wash components.

Drying results with RO-Water

| | | Stainless steel | | Glass | | Plastic | |
|---|---|---|---|---|---|---|---|
| All tests added to main wash: 400 ppm | | Time; | Drop- | Time; | Drop- | Time; | Drop- |
| STPP + 400 ppm SMS 5AQ + 30 ppm NaDCCA | | Sec. | lets # | Sec. | lets # | Sec. | lets # |
| 6A | No other components added to main | 300 | 20 | 300 | 6 | 300 | 25 |
| | wash: reference test | | | | | | |
| 6B | As 6A: plus separate rinse aid A: | 300 | 9 | 124 | 0 | 300 | 5 |
| | 0.3 g/L. | | | | | | |
| 6C | As 6A: plus 15 ppm Jaguar | 63 | 0 | 30 | 0 | 300 | 3 |
| | C 1000 added to main wash | | | | | | |

Drying Coefficients

| | | Drying Coefficient | |
|---|---|---|---|
| | | | Number of |
| All tests added to main wash: 400 ppm | | Drying | remaining |
| STPP + 400 ppm SMS 5AQ + 30 ppm NaDCCA | | time | droplets |
| 6A | No other components added to main | — | — |
| | wash: reference test. | | |
| 6B | As 6A: plus separate rinse aid A: | 0.80 | 0.22 |
| | 0.3 g/L. | | |
| 6C | As 6A: plus 15 ppm Jaguar | 0.44 | 0.04 |
| | C 1000 added to main wash | | |

The substrates were also evaluated visually on spots (water marks), when they were totally dried.

Visible Spots on Substrates

| Test | Stainless steel | Glass | Plastic |
|---|---|---|---|
| 6A | Yes | Yes | Yes |
| 6B | Yes | Yes | Yes |
| 6C | No | No | Yes |

This example confirms that the product containing polysaccharide provides also very good drying properties in RO-water. The results are significantly better than for a standard separate rinse aid, leading to faster drying, less remaining droplets and improved visual appearance.

### Example 7

In this example the drying behaviour is tested for a liquid detergent containing polysaccharide which is dosed in a relatively concentrated solution via the Divojet® concept of JohnsonDiversey.

The same products as described in example 5, ‘PS-liquid detergent’ and reference liquid detergent are applied in this test. Furthermore rinse aid A (as described in example 1) is used in this example.

### Wash Process

An institutional multi tank machine was used for these trials: Hobart FTN-ESB. This multi-tank machine has 3 wash tanks and 1 rinse section. The Divojet system was installed at the beginning of the second wash tank. Soft water was applied via this Divojet nozzles (at 30 L/H) and via the rinse section (at 270 L/H). No product is directly dosed in the first and last wash tanks; these tanks have standard nozzles in which the wash water is pumped around over the substrates. The contact time of the substrates with each of the tanks is about 30 seconds. The temperature of the main wash solution was 50° C. and of the rinse water 80° C.

The liquid detergent was dosed via the Divojet system at 20 g/L in the middle wash tank. This relatively concentrated wash solution was in contact with the substrates for 30 seconds; then the substrates are rinsed with wash water from the last wash tank; this wash water has a much lower detergent concentration since only product dosed via the Divojet system enters this tank and is then diluted by the much higher volume of water entering via the rinse section. Under these conditions the detergent concentration in the last tank will become about 2 g/L.

Working Method

The drying performance was measured with similar coupons as described in example 1.

First (reference test 7A) the drying behavior is determined for a wash process in which no rinse components are present (not dosed via the separate rinse and not added to the main wash process). The reference liquid detergent (as described in example 5) is dosed via Divojet.

Then (test 7B) the drying behaviour of this process with a standard rinse process is determined. In this standard rinse process, rinse aid A is dosed in the separate rinse section at 0.3 g/L.

Then (test 7C) the drying behaviour is determined for a wash processes in which no rinse component is dosed in the rinse flow (so rinsed only with fresh soft water) but where ‘PS-liquid detergent’ (which contains 0.5% Jaguar C1000) is dosed via Divojet in the second wash tank.

Drying Results for Dosing via Divojet

| | | Stainless steel | | Glass | | Plastic | |
|---|---|---|---|---|---|---|---|
| All tests: liquid main wash | | Time; | Drop- | Time; | Drop- | Time; | Drop- |
| detergent dosed via Divojet | | Sec. | lets # | Sec. | lets # | Sec. | lets # |
| 7A | Reference liquid detergent | 300 | 33 | 202 | 0 | 300 | 15 |
| 7B | As 7A: plus separate rinse aid A: | 300 | 17 | 127 | 0 | 300 | 5 |
| | 0.3 g/L. | | | | | | |
| 7C | PS-liquid detergent | 300 | 4 | 55 | 0 | 197 | 0 |

Drying Coefficients

Drying Coefficient

| | | Number of |
|---|---|---|
| All tests: liquid main wash | Drying | remaining |
| detergent dosed via Divojet | time | droplets |

| | | | |
|---|---|---|---|
| 7A | Reference liquid detergent | — | — |
| 7B | As 7A: plus separate rinse aid A | 0.88 | 0.42 |
| 7C | PS-liquid detergent | 0.64 | 0.06 |

This example illustrates that the liquid product containing a low level of polysaccharide provides also very good drying properties when dosed in a concentrated version, such as performed in the Divojet concept, followed by rinsing with fresh water only. These results are significantly better than for the reference liquid detergent without polysaccharide, applied in the same concentrated version via the Divojet concept and where is rinsed with a standard separate rinse aid.

### Example 8

In this example the drying behaviour is tested for a ware washing concept in which the substrates are washed periodically with a detergent containing a relatively high level of polysaccharide.

The same dishwashing machine, wash process and drying test method is used as described in example 1, but now tap water is used in main wash and in the rinse.

First (reference test 8A) the drying behavior is determined for a wash process in which no rinse components are present (not dosed via the separate rinse and not added to the main wash process). In this case, the mainwash contains the following main wash powder: 0.50 g/l sodium tripoly phosphate (STP; LV 7 ex-Rhodia) 0.35 g/l sodium metasilicate 5 Aq.+0.10 g/L sodium hydroxide+0.03 g/l dichloroisocyanuric acid Na-salt. 2aq (NaDCCA).

Then (test 8B) the drying behavior is determined for a wash processes in which no rinse component is dosed in the rinse flow (so rinsed only with fresh tap water) but where 0.20 g/L Jaguar C 1000 was added to the main wash together with the other main wash components.

After test 8B the machine was emptied and cleaned severely to remove any remaining polysaccharide. Then (test 8C) a drying test was done with the substrates washed before in test 8B under the same conditions as in test 8A: so no drying components present. This washing process with the same substrates was repeated in total 10 times. The drying behaviour was tested after 5 washes (test 8D) and 10 washes (test 8E).

Drying Results

| All tests added to main wash: 500 ppm | | Stainless steel | | Glass | | Plastic | |
|---|---|---|---|---|---|---|---|
| STPP + 350 ppm SMS 5AQ + 100 ppm | | Time; | Drop- | Time; | Drop- | Time; | Drop- |
| NaOH + 30 ppm NaDCCA | | Sec. | lets # | Sec. | lets # | Sec. | lets # |
| 8A | Reference test: no other components | 300 | 22 | 300 | 4 | 300 | 28 |
| 8B | As 8A: plus 200 ppm Jaguar C 1000 | 30 | 0 | 30 | 0 | 30 | 0 |
| | added to main wash | | | | | | |
| 8C | As 8A: substrates used from test 8B; | 30 | 0 | 30 | 0 | 30 | 0 |
| | 1 extra wash without rinse component | | | | | | |
| 8D | As 8A: substrates used from test 8B; | 30 | 0 | 30 | 0 | 30 | 0 |
| | 5 extra washes without rinse component | | | | | | |
| 8E | As 8A: substrates used from test 8B; | 30 | 0 | 30 | 0 | 30 | 0 |
| | 10 extra washes without rinse component | | | | | | |

Drying Coefficients

| | | Drying Coefficient | |
|---|---|---|---|
| All tests added to main wash: 500 ppm | | | Number of |
| STPP + 350 ppm SMS 5AQ + 100 ppm | | Drying | remaining |
| NaOH + 30 ppm NaDCCA | | time | droplets |
| 8A | No other components added to main | — | — |
| | wash: reference test. | | |
| 8B | As 8A: plus 200 ppm Jaguar C 1000 | 0.13 | 0 |
| | added to main wash | | |
| 8C | As 8A: substrates used from test 8B; | 0.13 | 0 |
| | 1 extra wash without rinse component | | |
| 8D | As 8A: substrates used from test SB; | 0.13 | 0 |
| | 5 extra washes without rinse component | | |
| 8E | As 8A: substrates used from test 8B; | 0.13 | 0 |
| | 10 extra washes without rinse component | | |

These results show that the relatively high level of 200 ppm Jaguar C1000 in the main wash leads to excellent drying on all substrates: test 8B. Furthermore, it might be concluded that this polysaccharide is adsorbed very substantively. Because, test 8C, 8D and 8E show that these substrates are also dried excellent when washed in a process in which no extra polysaccharide is added and when is rinsed with water only. This illustrates that the polysaccharide can be applied periodically. A treatment using a detergent comprising polysaccharide may be alternated with one or more washings using a detergent without polysaccharide.

1. A method of washing ware comprising:
(a) contacting ware in a washing step with an aqueous cleaning composition in a ware washing machine, the aqueous cleaning composition comprising a major portion of an aqueous diluent and about 200 to 5000 parts by weight of a ware washing detergent per each one million parts of the aqueous diluent;
(b) contacting the ware after washing in a rinse step with an aqueous rinse, the aqueous rinse being substantially free of an intentionally added rinse agent, characterized in that the ware washing detergent contains a sufficient amount of a polysaccharide to provide a layer of polysaccharide on the ware so as to afford sheeting action in the aqueous rinse step;
wherein:
the polysaccharide has an average drying coefficient corresponding to the ratio
drying time using detergent with polysaccharide
drying time using detergent without polysaccharide being at the most 0.9, and/or corresponding to the ratio
number of droplets after 5 minutes using detergent with polysaccharide
number of droplets after 5 minutes using detergent without polysaccharide being at the most 0.5.

2. The method of claim 1, wherein the polysaccharide constitutes from 0.01% to 50% (w/w) of the detergent, from 0.1 to 20% (w/w), from 0.2 to 10% (w/w), from 0.5 to 5% (w/w), or from 1 to 5% (w/w).

3. The method of claim 1, wherein the polysaccharide is present in the aqueous cleaning composition in an amount of from 1 to 100 ppm, from 2 to 50 ppm, or from 5 to 50 ppm.

4. The method of claim 1, wherein the ware washing machine is an automatic institutional machine.

5. The method of claim 1, wherein the washing step comprises dosing of the detergent in a concentrated version and its subsequent dilution with aqueous diluent.

6. The method of claim 1, wherein the detergent and the polysaccharide are dosed as separate products into the washing step.

7. (canceled)

8. The method of claim 1, wherein polysaccharides having both an average drying coefficient based on drying time of >0.9 as well as an average drying coefficient based on remaining number of droplets of >0.4 are excluded.

9. The method of claim 1, wherein the polysaccharide is a cellulose-based and/or natural gum-based and/or pectin-based and/or starch-based polysaccharide.

10. The method of claim 9, wherein the natural gum-based polysaccharide is modified guar gum, xanthan gum, carrageenan and/or locust bean gum.

11. The method of claim 10, wherein the modified guar gum is Guar gum, 2-hydroxypropyl ether and/or Guar gum, 2 hydroxy-3-(trimethylammonium)propyl ether.

12. The method of claim 9, wherein the cellulose-based polysaccharide is selected from the group consisting of hydroxyethylcellulose, hydrophobically modified hydroxyethylcellulose, ethyl hydroxyethyl cellulose, hydrophobically modified ethyl hydroxyethyl cellulose, hydroxypropylcellulose and sodium carboxymethylcellulose.

13. The method of claim 1, wherein the polysaccharide is combined with other polysaccharides and/or with nonionic or polymeric surfactants in the ware washing detergent.

14. The method of claim 1, wherein the ware washing detergent is in the form of a powder, granulated powder, tablet, solid block or is a combination of powder and tablet in a sachet.

15. The method of claim 1, wherein the ware washing detergent is in liquid, structured liquid or gel form.
